(19) United States
(12) Patent Application Publication
(10) Pub. No.: US 2014/0157189 A1
(43) Pub. Date: Jun. 5, 2014

(54) OPERATION APPARATUS, IMAGE FORMING APPARATUS, AND STORAGE MEDIUM

(71) Applicant: CANON KABUSHIKI KAISHA, Tokyo (JP)

(72) Inventor: Seijiro Morita, Kawasaki-shi (JP)

(73) Assignee: CANON KABUSHIKI KAISHA, Tokyo (JP)

(21) Appl. No.: 14/090,273

(22) Filed: Nov. 26, 2013

(30) Foreign Application Priority Data
Nov. 30, 2012 (JP) 2012-261940

(51) Int. Cl. G06F 3/0482; G06F 3/0485

(52) U.S. Cl. CPC G06F 3/0482; G06F 3/0485
USPC 715/784

(57) ABSTRACT

An operation apparatus displays a plurality of objects in an object display area of a display screen which can be operated by a finger or a pen, retracts at least one target object in the object display area, which is selected by a selection operation, outside the object display area, deletes the display of the at least one target object, scrolls the objects remaining in the object display area in a direction in which a scroll operation is performed in the object display area, inserts the at least one target object into an insertion position specified by an insertion operation in the object display area, and updates the display of the objects in the object display area.

### BACKGROUND OF THE INVENTION

1. Field of the Invention

The present disclosure generally relates to image forming and, more particularly, to an operation apparatus and an image forming apparatus equipped with a display screen such as a touch screen display, for example, which can be operated by a finger or a pen.

2. Description of the Related Art

Some of image forming apparatuses such as a printer or a digital multifunction peripheral have a function to print a photo image captured by a digital camera or document data downloaded from the Internet. Most of the image forming apparatuses are equipped with a touch screen display for displaying a preview image whereby to previously check read images or print results. The touch screen display has an advantage in that it can be easily and intuitively operated because instructions can be input by directly touching its display screen.

In recent years, a mobile terminals has become multi-functional and the touch screen display is generally used in the display unit of the mobile terminal, of which working environment is not so different from that of a personal computer. In future, it is expected that the environment for editing work is constructed through the display screen of the touch screen display of the mobile terminal.

The touch screen display is restrictive in a display area. For example, if a display image is moved to a position where it is not displayed on the screen, the screen needs to be scrolled until the position is displayed. As a conventional technique for that, there has been known an operation apparatus discussed in Japanese Patent Application Laid-Open No. 2012-48525. In the operation apparatus, in a case where any of display images is selected in a display screen, and if an instruction for movement to an area of a plurality of display images other than those is issued, the plurality of display images is scrolled. For example, if a selected display image on page 5 is held by one finger at the end of the display screen and a plurality of other display images selected by another finger is scrolled to reach a desired position between pages 15 and 16, the selected display image on page 5 is inserted into the position.

In the operation apparatus discussed in Japanese Patent Application Laid-Open No. 2012-48525, if a plurality of images other than the selected display image is scrolled, the plurality of images cannot stop at the desired position and sometimes passes over the position. In the above example, scrolling cannot stop at page 15 and sometimes continues to page 17. In this case, the plurality of images is scrolled in the reversed direction to return to a position on page 15. In other words, the selected display image on page 5 is temporarily moved to the position at the opposite end of the display screen and needs to be held (waited) there until the scroll is stopped on page 15. This impairs user's convenience.

Some of the touch screen display enables a multi-touch operation such as pinch-in and pinch-out, for example. These operations are often allocated to reduction and expansion processing of an image.

The operation apparatus discussed in Japanese Patent Application Laid-Open No. 2012-48525 takes an operation performed after a state of selecting a display image is detected as a movement instruction, and enters a movement mode for moving the display image. For this reason, the operation apparatus needs to escape from the movement mode to perform the multi-touch operation on the display image. The operation apparatus uses information about the position and the stop state of the selected image to detect the state where the display image is selected. The difference between the selection operation of the display image and the multi-touch operation is not intuitive, which may lead to a user's erroneous operation.

### SUMMARY OF THE INVENTION

The present disclosure provides user interface technique capable of effectively adjusting the position of a display image by an intuitive operation without a user's erroneous operation.

The present disclosure provides an operation apparatus and an image forming apparatus to which the above user interface technique is applied, and a storage medium.

The operation apparatus of an aspect of the present disclosure includes an object display unit, a selection unit, a scrolling unit, and an insertion unit.

The object display unit displays a plurality of objects in an object display area of a display screen which can be operated by a finger or a pen.

The selection unit retracts at least one target object in the object display area, which is selected by a selection operation, outside the object display area and deletes the display of the at least one target object.

The scrolling unit scrolls the objects remaining in the object display area in the direction in which a scroll operation is performed in the object display area.

The insertion unit inserts the at least one target object into an insertion position specified by an insertion operation in the object display area and updates the display of the object in the object display area.

An aspect of the image forming apparatus of the present disclosure includes the abovementioned operation apparatus, a communication unit, and an image processing unit. The communication unit communicates with the operation apparatus. The image processing unit transmits a plurality of objects to the operation apparatus, and subjects the plurality of objects to image processing reflecting operation contents which the operation apparatus applies to the plurality of objects.

A computer program stored in the storage medium of an aspect of the present disclosure causes a computer to operate as the abovementioned operation apparatus. More specifically, the computer program causes the computer to function as the object display unit, the selection unit, the scrolling unit, and the insertion unit.

Further features and aspects of the present disclosure will become apparent from the following detailed description of exemplary embodiments with reference to the attached drawings.

### BRIEF DESCRIPTION OF THE DRAWINGS

FIG. 1 is a block diagram illustrating principal elements of an image forming apparatus according to a first exemplary embodiment of the present disclosure.

FIG. 2 illustrates an example of a touch screen of an operation terminal.

FIGS. 3A and 3B illustrate page editing screens according to the first exemplary embodiment.

FIGS. 4A, 4B, and 4C illustrate a page extraction operation according to the first exemplary embodiment.

FIGS. 5A and 5B illustrate a page extraction operation according to the first exemplary embodiment.

FIGS. 6A, 6B, and 6C illustrate a page insertion operation according to the first exemplary embodiment.

FIGS. 7A and 7B illustrate a page insertion operation according to the first exemplary embodiment.

FIG. 8 illustrates a chart of control procedures for a page movement operation according to the first exemplary embodiment.

FIG. 9 illustrates a screen for confirming operation completion according to a second exemplary embodiment.

FIG. 10 illustrates a chart of control procedures for a page movement operation according to the second exemplary embodiment.

FIG. 11 illustrates a chart of control procedures for a page movement operation according to a third exemplary embodiment.

FIGS. 12A, 12B, and 12C illustrate a page insertion order selection screen according to a fourth exemplary embodiment.

FIGS. 13A and 13B illustrate an insertion page selection screen according to the fourth exemplary embodiment.

FIG. 14 illustrates a chart of control procedures for a page movement operation according to the fourth exemplary embodiment.

FIGS. 15A, 15B, 15C, and 15D illustrate a page extraction operation according to a fifth exemplary embodiment.

FIG. 16 illustrates a chart of control procedures for page movement operation according to the fifth exemplary embodiment.

FIGS. 17A, 17B, 17C, 17D, 17E, and 17F illustrate a movement operation of icon images according to a sixth exemplary embodiment.

### DESCRIPTION OF THE EMBODIMENTS

Various exemplary embodiments, features, and aspects of the disclosure will be described in detail below with reference to the drawings.

### [Configuration of Image Forming Apparatus]

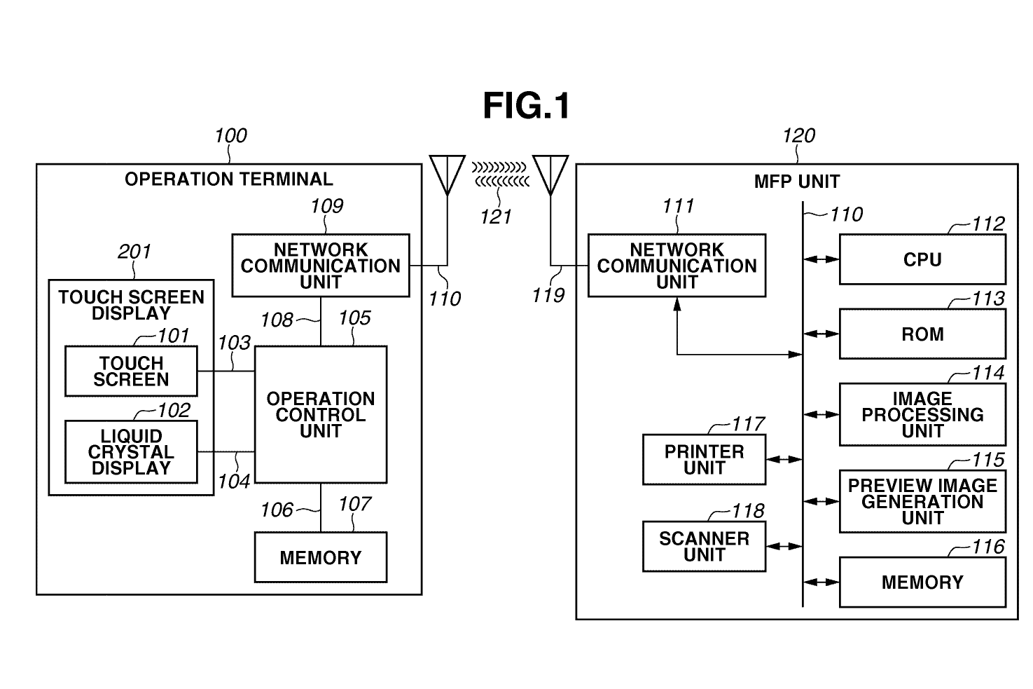

FIG. 1 is a block diagram illustrating principal elements of an image forming apparatus according to a first exemplary embodiment of the present disclosure. The image forming apparatus is a multi-function printer which realizes functions such as reading, copying, printing, and facsimile transmitting/receiving, for example, and includes an operation terminal 100 and a multi-function printing unit (MFP unit) 120.

### [Configuration of Operation Terminal]

The operation terminal 100 is an information processing terminal equipped with a digital camera function for taking a photograph and a data capturing function for transferring documents and image data with the Internet via a wireless network circuit (not illustrated). The data captured by the digital camera function and the data capturing function is displayed on a liquid crystal display described below and operated via a touch screen.

The operation terminal 100 may be a dedicated unit which is attached to the MFP unit 120 or an electronic terminal such as a tablet separated from the MFP unit 120. In the present exemplary embodiment, a configuration using the electronic terminal as the operation terminal 100 is described. It is assumed that a computer program required for functioning the electronic terminal as the operation terminal 100 is implemented by separately downloading the computer program by a communication unit unique to the electronic terminal. As used herein, the term “unit” generally refers to any combination of software, firmware, hardware, or other component that is used to effectuate a purpose.

The operation terminal 100 includes a double-layer structure touch screen display 201 composed of a touch screen 101 and a liquid crystal display 102 as a display screen. The touch screen 101 is connected to an operation control unit 105 via an interface (hereinafter referred to as I/F) 103, and the liquid crystal display 102 is connected to the operation control unit 105 via an I/F 104.

A memory 107 is connected to the operation control unit 105 via an I/F 106. A network communication unit 109 is connected to the operation control unit 105 via an I/F 108.

The operation control unit 105 includes a central processing unit (CPU) and a non volatile random access memory which are not illustrated. The non volatile random access memory stores a control program and definition information of various types of operation patterns described below. The CPU executes the control program stored in the non volatile random access memory to totally control an operation environment provided for a user. More specifically, the CPU displays information on the touch screen display 201, detects contents of input by user's operation to the displayed information by a finger or a pen, and performs control processing according to the detected contents. At this point, data to be temporarily stored is stored in the memory 107 via the I/F 106 and read as required. If the operation control unit 105 needs to communicate with the MFP unit 120, a wireless communication line 121 is established. In other words, the operation control unit 105 controls the network communication unit 109 via the I/F 108 and enables communication with the MFP unit 120 via an antenna 110 by a wireless LAN (WLAN).

### [Internal Configuration of MFP Unit]

The MFP unit 120 is a kind of a computer apparatus provided on the image forming apparatus. The MFP unit 120 is provided with a data bus I/F 110 having a function to transfer data by a direct memory access controller (DMAC). A network communication unit 111, a CPU 112, and a read only memory (ROM) 113 are connected to one another via the data bus I/F 110. An image processing unit 114, a preview image generation unit 115, a memory 116, a printer unit 117, and a scanner unit 118 are also connected to the data bus I/F 110. An antenna 119 is connected to the network communication unit 111.

The CPU 112 is a control module which executes the control program stored in the ROM 113 to totally control each operation of units 111 and 114 to 118 including data transfer. Assuming that the operation terminal 100 issues an instruction for scan processing and a document is placed on a document positioning plate (not illustrated). The CPU 112 controls the scanner unit 118 to read a document image. The read document image is referred to as scan data. The scan data is converted into digital data by the scanner unit 118 and then stored in the memory 116. The data transferred from the operation terminal 100 in addition to the scan data is also stored in the memory 116.

The image processing unit 114 subjects various data stored in the memory 116 to image processing. The image processing unit 114 generates a setting menu screen image, a guide screen, or a confirmation screen described below to be displayed on the display screen of the operation terminal 100. The data generated by the image processing unit 114 is stored in the memory 116.

The preview image generation unit 115 generates preview image data for displaying a preview image from the data stored in the memory 116, associates the preview image data with preview source data, and stores the data in the memory 116.

The printer unit 117 subjects the various data or the preview image data stored in the memory 116 to print processing. If the printer unit 117 is an electrophotographic printer, for example, a laser pulse for forming a latent image on a photosensitive image by pulse width modulation (PWM) bearing member is generated. The latent image formed on the photosensitive image bearing member is transferred and fixed to a sheet (not illustrated) and output.

When the preview image is displayed on the touch screen display 201 of the operation terminal 100 (when such instruction is received by the operation terminal 100), the CPU 112 reads the preview image data stored in the memory 116. The CPU 112 controls the network communication unit 111 to transfer the data to the operation terminal 100 via the antenna 119 by the wireless communication line 121.

### [Touch Screen Display]

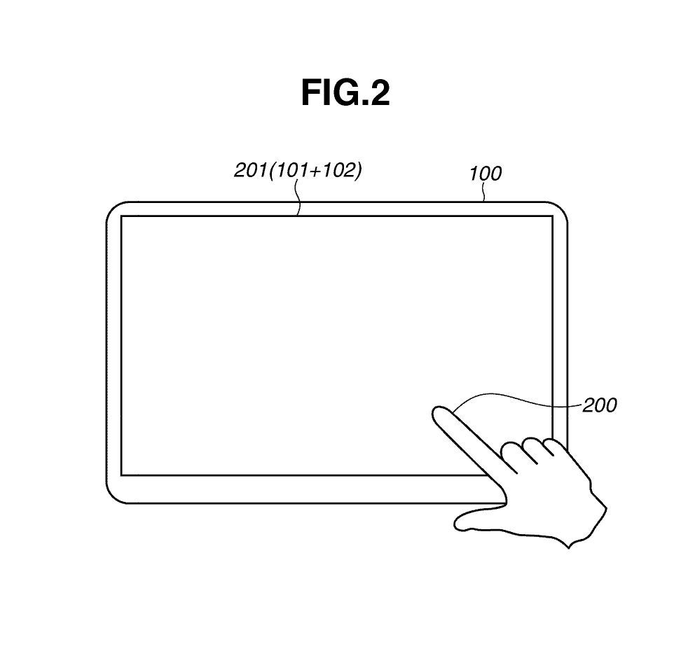

The touch screen display 201 of the operation terminal 100 is described below with reference to FIG. 2. The touch screen display 201 is configured such that the liquid crystal display 102 is disposed beneath the touch screen 101 made of a transparent material.

The liquid crystal display 102 displays various data received via the operation control unit 105 and the I/F 104. The various data refer to the data acquired by the above digital camera function and the data capturing function and the other data such as setting menu screen acquired by the MFP unit 120.

The touch screen 101 detects a position operated by a user's finger (a fingertip) 200 or a pen (a touch pen, not illustrated) on the display screen, in other words, the coordinate of the position and the change thereof. The data representing the thus detected coordinate of the position and the change thereof is stored in the memory 107.

Such an operation causes the operation terminal 100 to display the above described various data on the touch screen display 201, and various types of processing can be allocated by the operation of the display screen. The various types of processing refer to selection of an operation mode, a setting of a function, an instruction for an operation, selection or movement at the time of editing processing of the display image, a definition of a screen operation such as touch, drag, pinch, and flick at that time, specification of a desired position (coordinate) on the display image, and other processing. The contents of the allocated processing are transferred to the MFP unit 120 as required.

### [Adjustment of Position on Page of Preview Image]

The concept that the user adjusts the position of the preview images in units of pages being an example of an object via the touch screen display 201 of the operation terminal 100 is described below as an example of an operation of the image forming apparatus.

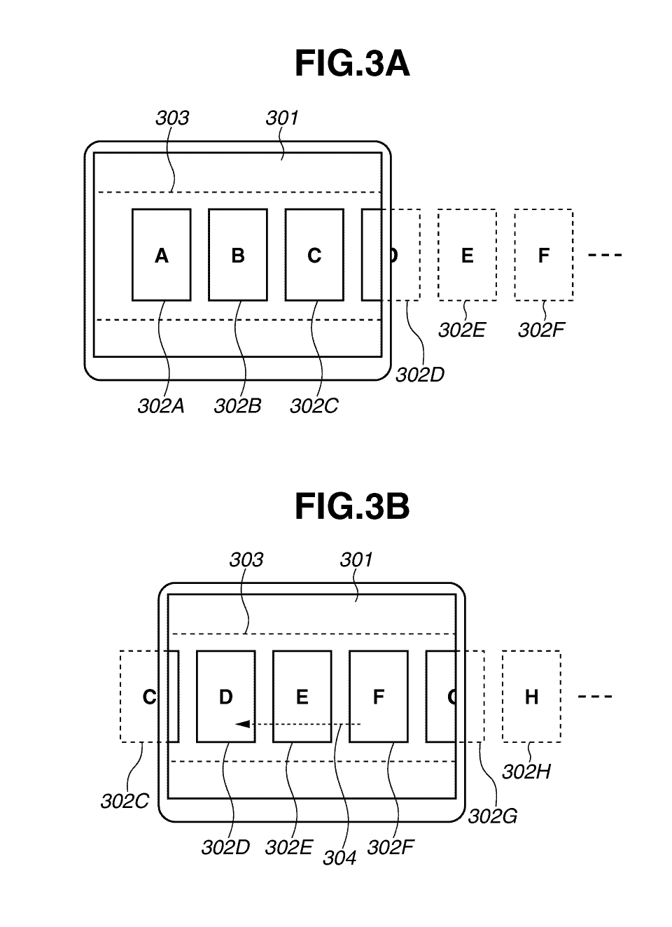

FIG. 3A illustrates a display screen 301 of the preview images displayed on the touch screen display 201 of the operation terminal 100. In the illustrated example, preview images 302A to 302D on a plurality of pages read from one copy of a document by the scanner unit 118 of the MFP unit 120 are displayed on the display screen 301. The operation control unit 105 displays the preview images 302 in an object display area 303 using the preview image data transferred from the MFP unit 120.

Other preview images 302E, 303F and the like classified into the same group exist on the page of the preview image 302D and the subsequent pages, although they are not displayed on the touch screen display 201 because of the limitation of size of the display area. As illustrated in FIG. 3B, all of the preview images 302 of the same group are moved by a touch operation of a scroll 304 for moving the preview images from right to left on the touch screen display 201. Such processing for moving the preview images can be performed by using a known technique.

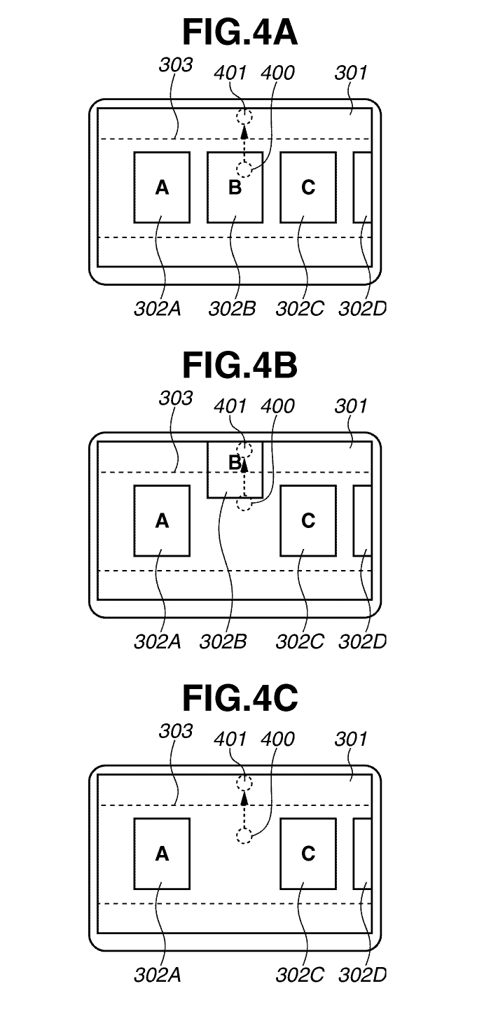

In FIG. 4A, if the user wants to move the preview image 302B, the user touches a position 400 of the preview image 302B and drags the preview image 302B from the position 400 to a position 401 that is outside an object display area 303. Then, the finger is released from the screen at the position 401. A drag operation refers to an operation for moving the finger on the screen with a position selected by a touch operation. Such an operation pattern is a selective operation pattern and previously defined.

FIG. 4B illustrates an example of a display mode of the preview image during the drag operation. FIG. 4C illustrates a display screen 301 displayed after the user releases the finger. Thus, the preview image 302B is retracted outside the object display area 303 and its display is also deleted.

The examples illustrate in which the preview image continues to be displayed even during its drag operation, however, such a display mode does not always need be adopted. The preview screen may be updated such that a distance between the remaining preview images is reduced after the moved preview image is selected to display the preview image 302C next to the preview image 302A.

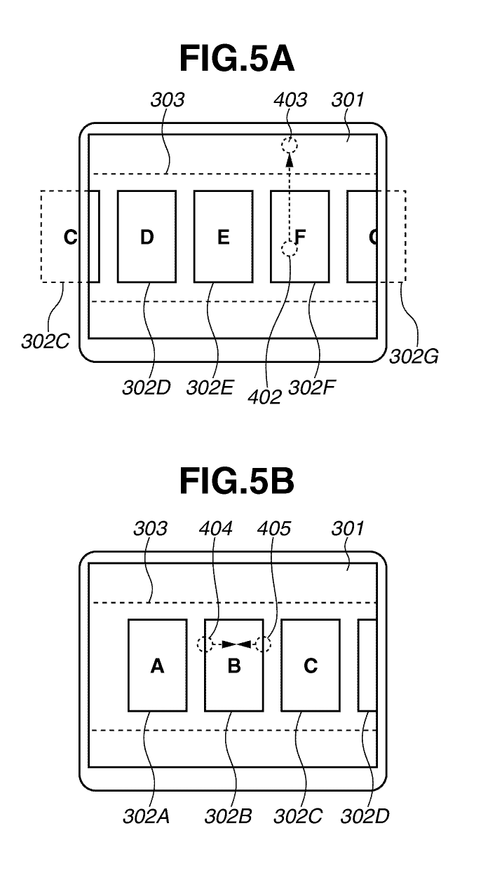

As illustrated in FIG. 5A, if the user wants to move a preview image 302F as well, the preview image 302F is retracted in the same manner as that in FIG. 4A. In other words, after drag operations 402 and 403 are finished, the finger is released from the screen. Thereby, the two preview images 302B and 302F to be moved are determined.

As illustrated in FIG. 5B, a pinch-in operation in which the preview image to be moved is moved such that positions 404 and 405 on both sides thereof are pinched with two fingers may be used to select the preview image to be moved as a selection operation pattern.

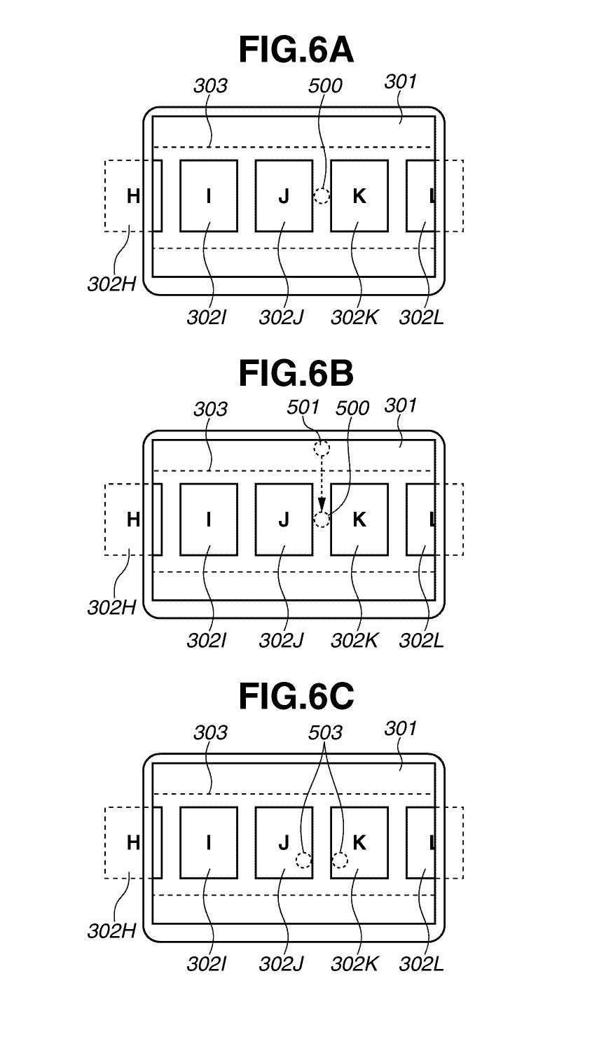

The motion of the display screen in a case where the retracted preview images 302B and 302F are moved to and inserted into a space between the preview images 302J and 302K illustrated in FIG. 6A is described below.

The user specifies an insertion position 500 by touching the insertion position 500 of the space between the preview images 302J and 302K with a finger.

As illustrated in FIG. 6B, a slide is performed from a position 501 outside the object display area 303 to the insertion position 500. Such an operation pattern is an insertion operation pattern and previously defined.

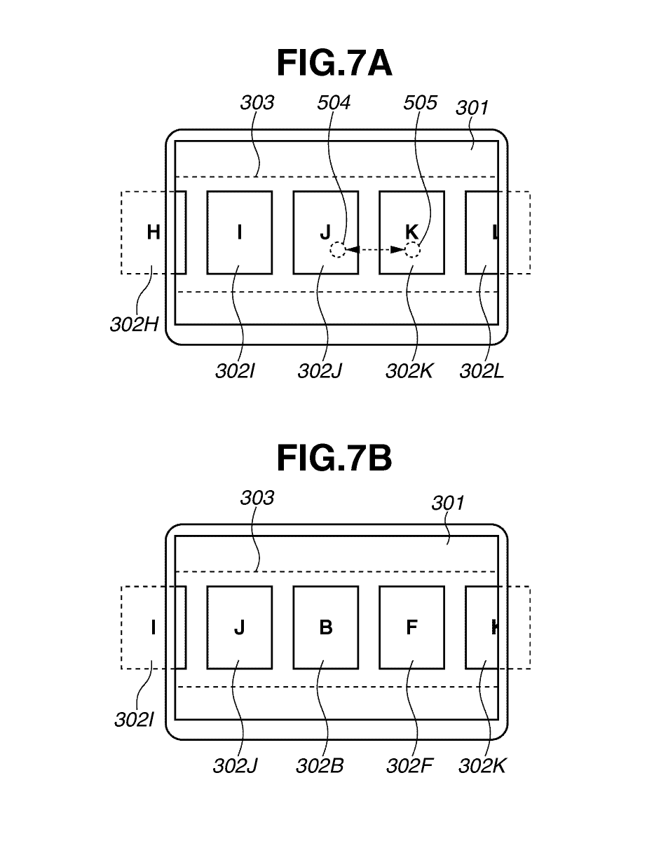

As illustrated in FIG. 6C, the insertion operation pattern may be a pattern in which predetermined positions 503 of two adjacent preview images 302J and 302K are touched at the same time. As illustrated in FIG. 7A, the insertion operation pattern may be a pinch-out operation performed such that predetermined positions 504 and 505 of the two preview images 302J and 302K are expanded by two fingers, respectively. In other words, the pinch-out operation is a pattern performed such that something is inserted between pages, for example.

FIG. 7B illustrates a state where the insertion of the preview images is completed by such an operation. In FIGS. 4A and 5A, the preview images are inserted in the order they are selected. However, they may be inserted in the reverse order.

### [Operational Contents of Operation Terminal]

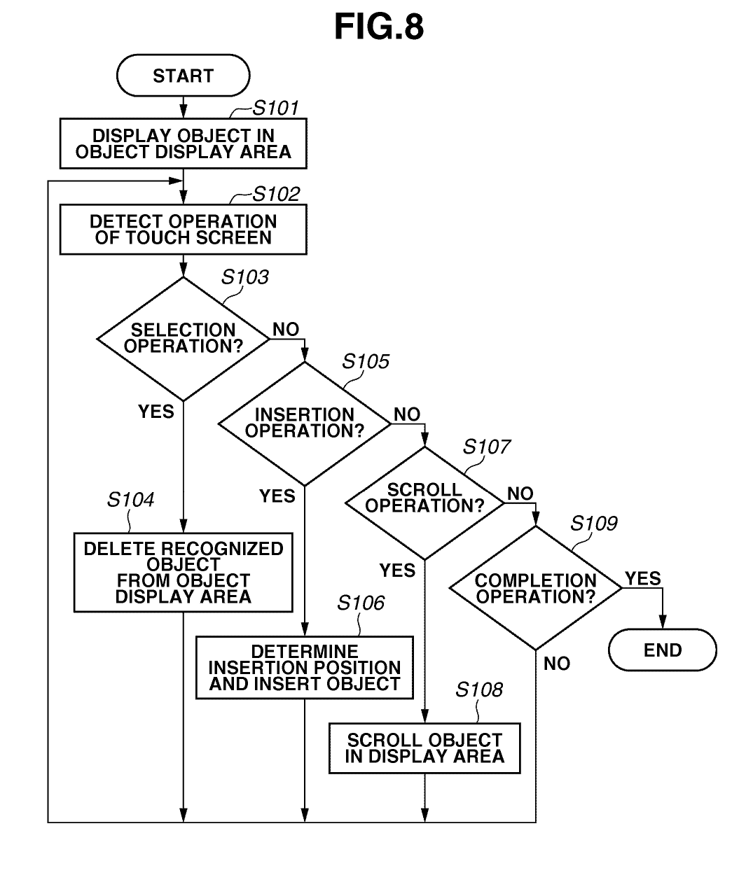

Operational contents of the operation terminal 100 in adjusting the position of the preview image in FIGS. 4 to 7 are described below with reference to FIG. 8. FIG. 8 illustrates a chart of procedures for control performed by the operation control unit 105 (CPU).

In step S101, the operation control unit 105 performs display control for displaying a plurality of grouped objects, i.e., a plurality of preview images, in the object display area 303 to display the display contents illustrated in FIG. 3A on the touch screen display 201. In step S102, the user detects the operational contents on the touch screen 101.

In step S103, the operation control unit 105 determines whether the detected operational contents relate to a selection operation for selecting a preview image to be moved. The determination is made based on whether the detected operational contents adapt to the selection operation pattern representing the selection of a specific preview image from a plurality of predetermined preview images. A pattern to be selected is a pattern of operation for moving outside the object display area 303 (the positions 400 and 401 in FIG. 4A) or a pattern of the pinch-in operation (the positions 404 and 405 in FIG. 5B), for example.

If the detected operational contents adapt to the selection operation pattern (YES in step S103), in step S104, the operation control unit 105 retracts the preview image to be moved into the memory 107 and deletes the display thereof from the object display area 303. Thereafter, the processing returns to step S102. As illustrated in FIG. 5A, if the number of preview images to be moved is equal to or greater than two, steps S102 to S104 are repeated.

If the detected operational contents do not adapt to the selection operation (NO in step S103), in step S105, the operation control unit 105 determines whether the detected operation is the insertion operation for inserting an preview image between pages. The determination is made based on whether the detected operation adapts to a predetermined insertion operation pattern associated with the specification of an insertion position. The insertion operation pattern refers to a slide operation performed to a position corresponding to the position between the preview images (the positions 500 and 501 in FIGS. 6A and 6B), the touch operation (the position 503 in FIG. 6C), or the pinch-out operation (the positions 504 and 505 in FIG. 7A), for example. Although an illustration is omitted, an icon image is kept displayed at a position into which an image can be inserted, and a pattern of the touch operation to the icon image may be taken as the insertion operation pattern.

If the detected operation is the insertion operation (YES in step S105), in step S106, the operation control unit 105 determines an insertion position (coordinate information) and inserts the preview image to be moved into the insertion position. After that, the operation control unit 105 rearranges the preview images (refer to FIG. 7B). The processing is enabled by sorting the image data of the preview images stored in the memory 107.

If the detected operation is not the insertion operation (NO in step S105), in step S107, the operation control unit 105 determines whether the detected operation is a scroll operation for scrolling the preview image which is being displayed. The determination is made based on whether the detected operation adapts to a predetermined scroll operation pattern. The scroll operation is a flick operation in the object display area 303, for example. The flick operation refers to an operation in which the displayed preview image is moved with the finger touching the touch screen display 201 irrespective of the current position of the preview image.

If the operation control unit 105 determines that the detected operation is the scroll operation (YES in step S107), in step S108, the operation control unit 105 performs control for moving the preview image being displayed based on a locus of the position detected in the touch screen display 201. The preview image may be slid while being displayed or moved while switching display screens in units of a plurality of pages.

If the operation control unit 105 determines that the detected operation is not the scroll operation (NO in step S107), in step S109, the operation control unit 105 determines whether the detected operation is a completion operation of movement and insertion processing. The determination is made based on whether the detected operation adapts to a predetermined completion operation pattern. The completion operation pattern is performed based on whether a touch on a completion button (not illustrated) on the touch screen display 201 is detected or a press of a start key (not illustrated) is detected, for example. If the detected operation is the completion operation (YES in step S109), the operation control unit 105 finishes the processing of page movement. At this point, the operation control unit 105 transmits setting information about the page movement acquired in such operation sequence to the MFP unit 120. If the detected operation is not the completion operation (NO in step S109), the processing returns to step S102.

When the preview image is moved by the above control procedure of the operation control unit 105, the user can be provided with an intuitive user interface. More specifically, the user specifies one or more preview images to be moved with the finger or a pen to allow retracting them, and the user only specifies the position between pages at an insertion (movement) destination to allow completing the adjustment of position of the preview images. For this reason, for example, the position of the preview image can be adjusted with an easy operability such that a sheet of paper is temporarily pulled out from a bundle of sheets and then inserted between other different sheets. At this point, there is no need for keeping the preview image to be moved pressed with the finger, so that operation is simplified. Each operation pattern is previously defined, so that there is no need for restricting a multi-touch operation unlike conventional techniques.

In a first exemplary embodiment, the movement of the preview image is described as an example. The present exemplary embodiment is not limited to the example, but can be applied to the adjustment of position of an icon image displayed on a screen of a smart phone or a tablet PC.

In the first exemplary embodiment, there is described an example in a case where the operation terminal 100 performs the selection operation, the insertion operation, the scroll operation, and the completion operation in this order at the time of a page movement operation. However, there is assumed a case where the selection operation is transferred to the completion operation immediately after the selection operation is completed. For example, after the user performs the selection operation of the preview image, the user erroneously inputs an instruction for the completion operation of the preview image without issuing an instruction for inserting thereof. In a second exemplary embodiment, an example of display control for coping with an unintended erroneous operation is described below.

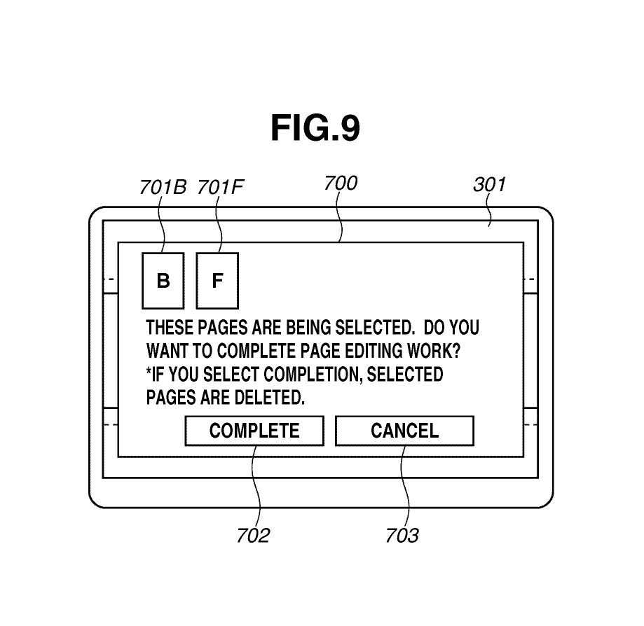

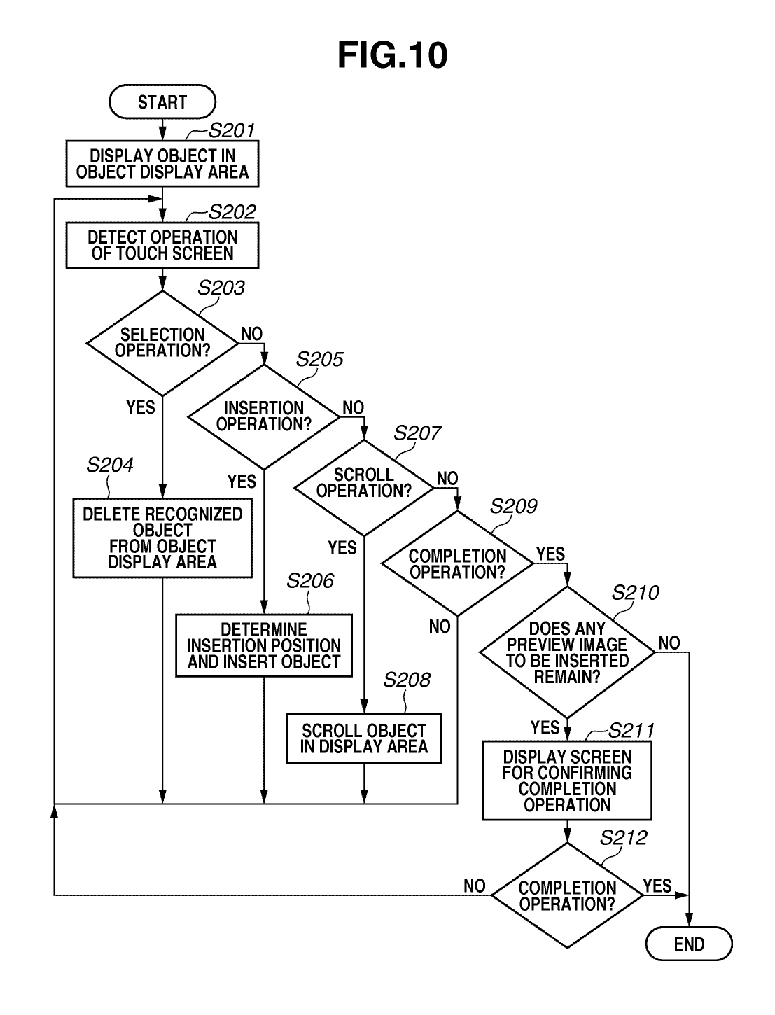

The operational contents of the operation terminal 100 in the second exemplary embodiment are described below with reference to FIGS. 9 and 10. FIG. 9 illustrates a screen for confirming operation completion at the time of moving pages. FIG. 10 illustrates control procedures executed by the operation control unit (CPU) 105 according to the present exemplary embodiment. Steps S201 to S209 in FIG. 10 are similar to steps S101 to S109 in FIG. 8 respectively. Therefore, the description of the duplicated portions is omitted.

In step S209, if the operation control unit 105 determines that the detected operation is the completion operation, in step S210, the operation control unit 105 determines whether a preview image to be inserted still remains in the preview images to be moved, based on whether a retracted preview image exists. If the operation control unit 105 determines that the retracted preview image exists (YES in step S210), in step S211, the operation control unit 105 displays a screen for confirming whether the processing for moving pages should be finished. FIG. 9 illustrates an example of a display screen. In the example of FIG. 9, there are displayed lists 701B and 701F of preview images that are not inserted yet, caution messages, a completion button 702, and a cancel button 703.

The user views the display screen and presses the completion button 702 if the processing should be finished or the cancel button 703 if the user is aware of his/her erroneous operation. For this reason, even if the completion operation is performed without performing the insertion operation, an object is not unintentionally deleted, and the preview image can be intuitively moved.

There is also assumed a case where the insertion operation is instructed before the selection operation is performed. For example, there is a case where the insertion position is previously specified and, thereafter, the preview image to be moved is selected. In a third exemplary embodiment, an example of a case capable of intuitively moving pages even under the above operation is described below.

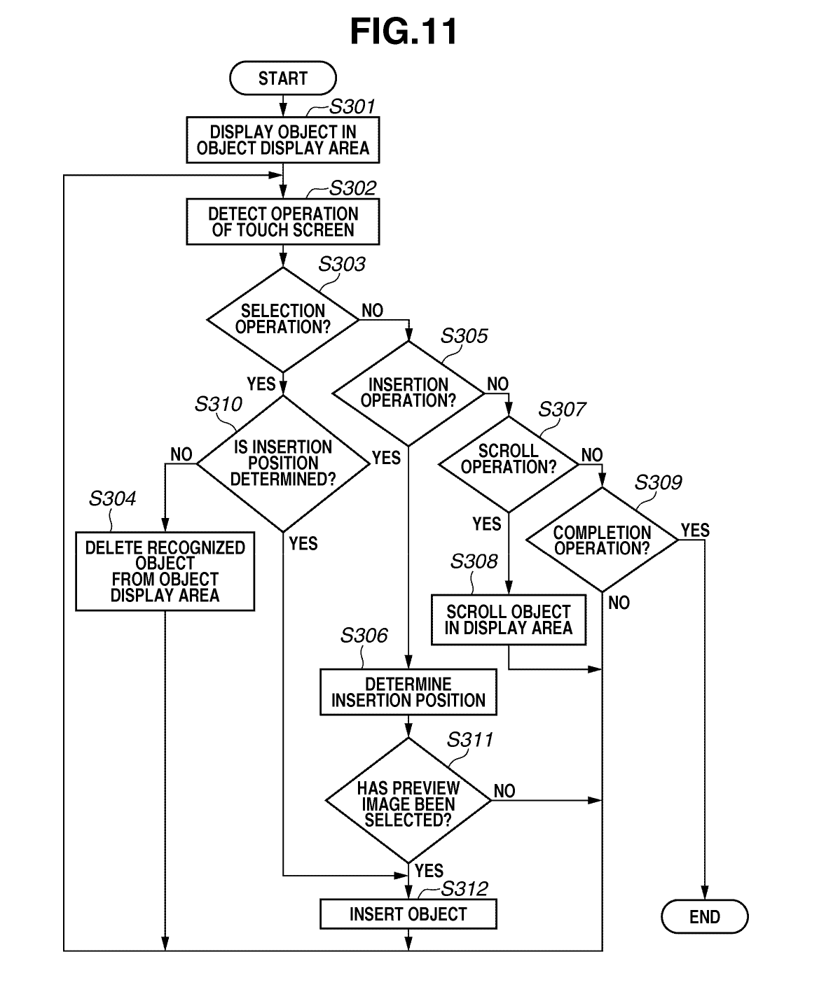

The operational contents of the operation terminal 100 in the exemplary embodiment are described below with reference to FIG. 11. FIG. 11 illustrates control procedures executed by the operation control unit (CPU) 105. Steps S301 to S305 are similar to steps S101 to S105 in FIG. 8 and steps S307 to S309 are similar to steps S107 to S109 in FIG. 8 respectively. Therefore, the description of the duplicated portions is omitted.

In step S305, if the operation control unit 105 determines that the detected operation is the insertion operation, in step S306, the operation control unit 105 determines a space between the preview images corresponding to the position detected at the time of the touch operation as an insertion position.

In step S311, the operation control unit 105 determines whether the preview image to be moved is already selected. If the preview image to be moved is already selected (YES in step 311), in step S312, the operation control unit 105 inserts the preview image into the insertion position. If the preview image to be moved is not selected yet (NO in step 311), the processing returns to step S302.

If the operation control unit 105 determines that the detected operational contents adapt to the selection operation (YES in step S303), in step S310, the operation control unit 105 determines whether the position where the preview image selected as an object to be moved is to be inserted is determined. If the insertion position is not determined (NO in step S310), in step S304, the operation control unit 105 deletes the preview image from the object display area 303. Thereafter, the processing returns to step S302.

If the insertion position is already determined (YES in step S310), in step S312, the operation control unit 105 inserts the preview image selected in step S303 into the insertion position. Such a control is performed to allow previously determining the insertion position if the insertion operation is performed before the selection operation is performed, so that the user's operability is more substantially improved as compared with a case where the insertion position cannot be previously determined.

In the first exemplary embodiment, the insertion operation is performed in a case where a plurality of the preview images to be moved is selected at the time of moving pages, all the preview images are inserted. However, some of the plurality of the preview images may be selected and inserted at the time of the insertion operation. In a fourth exemplary embodiment, an example capable of performing such an operation is described.

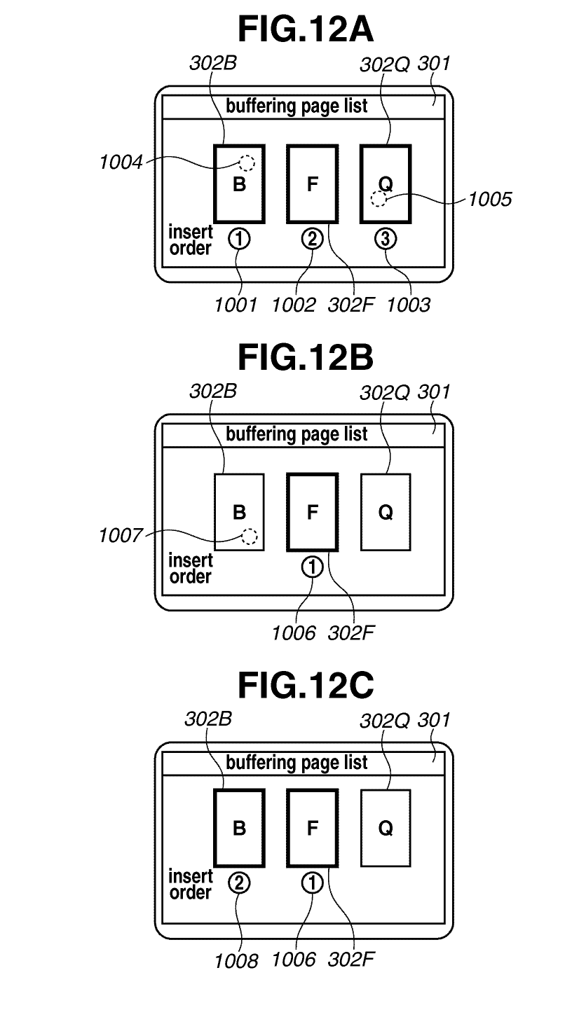

In FIG. 12A, the preview images 302B, 302F, and 302Q as preview images to be moved are displayed on the display screen 301 of the touch screen display 201. Order information concerning insertion 1001, 1002, and 1003 is displayed, each of the insertion order information being associated with their respective preview images. If all the preview images 302B, 302F, and 302Q are desired to be inserted in the illustrated insertion order as it is, the completion operation is input with a button (not illustrated). Thereby, the selection processing ends.

If only the preview image 302F is desired to be inserted, the display positions 1004 and 1005 of the preview images 302B and 302Q are touched. When the touch operation is completed, the display screen 301 is switched to that in FIG. 12B.

In other words, only the preview image 302F is displayed. Order information 1006 is also changed from “2” to “1.” Accordingly, only the preview image 302F is inserted. In this state, if the preview images 302F and 302B are desired to be inserted in this order, the display position 1007 of the preview image 302B is touched. Thereby, as illustrated in FIG. 12C, the preview images 302F and 302B are selected and Order information 1008 for inserting the preview image 302B is displayed as “2.” Performing the completion operation in this state enables insertion of the preview images 302F and 302B in the order indicated by the order information as illustrated.

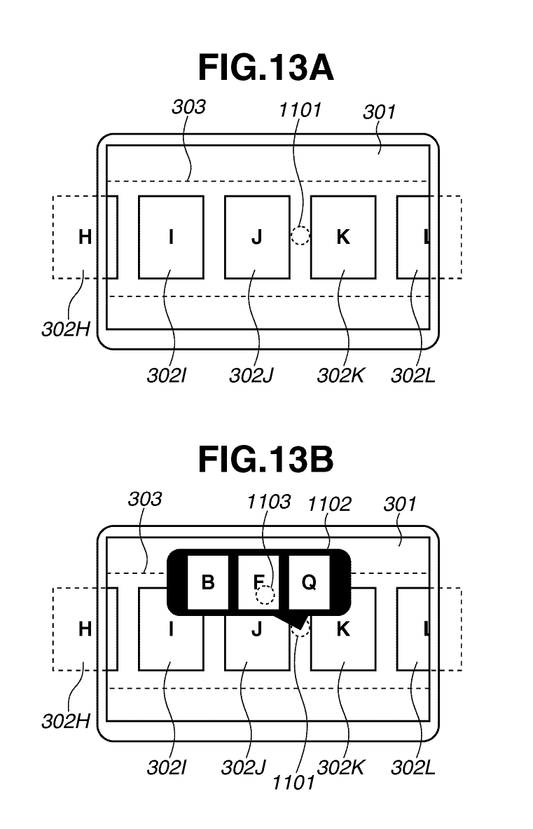

FIG. 13A illustrates a state where a plurality of the preview images to be moved are selected and an insertion position 1101 is determined. FIG. 13B illustrates an example of a pop-up display for selecting the preview image which can be inserted into the insertion position 1101. It is presumed that the page to be inserted is selected in the order of the preview images 302B, 302F, and 302Q. Then, the display of a pop-up display window 1102 is also sorted in that order. In this state, a display position 1103 of the preview image 302F is touched, as illustrated, to select and insert the preview image 302F into the insertion position 1101.

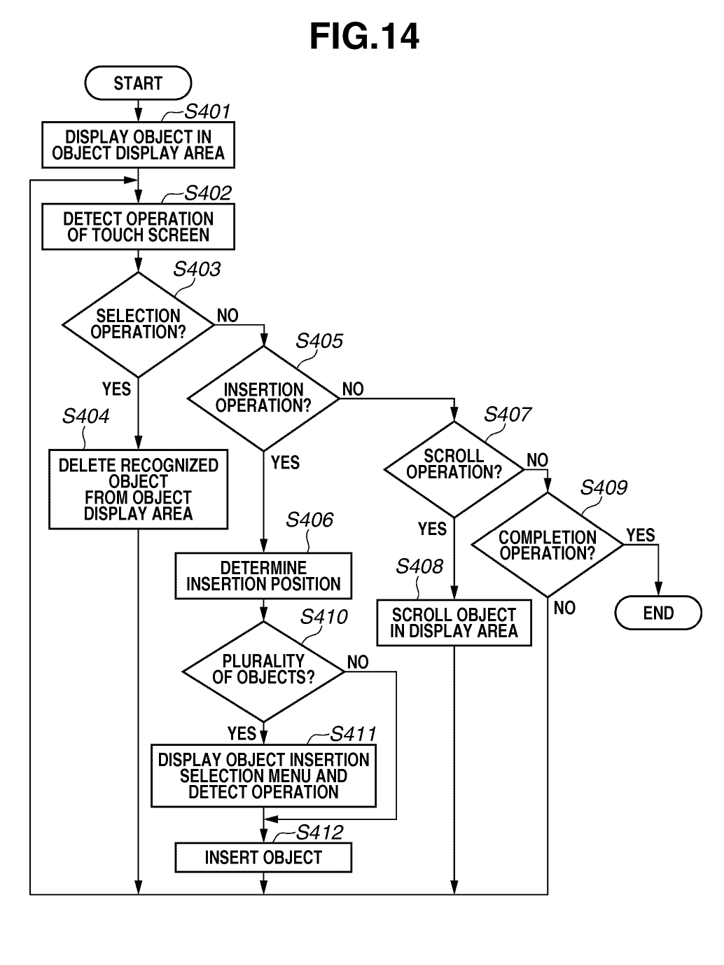

The operational contents of the operation terminal 100 enabling such processing are described below with reference to FIG. 14.

FIG. 14 illustrates control procedures executed by the operation control unit (CPU) 105. Steps S401 to S405 are similar to steps S101 to S105 in FIG. 8 respectively. Steps S407 to S409 are similar to steps S107 to S109 in FIG. 8 respectively. Therefore, the description of the duplicated portions is omitted.

If the operation control unit 105 determines that the detected operation is the insertion operation for inserting an preview image between pages (YES in step S405), in step S406, the operation control unit 105 determines a space between the preview images at the touched position as the insertion position.

In step S410, the operation control unit 105 determines whether a plurality of the preview images to be moved is selected. If only one preview image is selected instead of the plurality of the preview images (NO in step S410), in step S412, the operation control unit 105 inserts the preview image. Thereafter, the processing returns to step S402.

If the plurality of the preview images is selected (YES in step S410), in step S411, the operation control unit 105 displays an insertion selection menu for urging the user to select preview images to be inserted. In step S412, when the selection illustrated in FIG. 13B is performed on the display, the operation control unit 105 inserts the preview image in the selected order. Thereafter, the processing returns to step S402.

Even if a plurality of the preview images is selected, such a configuration is adopted to allow selecting a number of objects therefrom in any order and inserting the objects into a desired insertion position.

As the present exemplary embodiment is described above on the assumption that, if the insertion operation is detected with the plurality of the preview images selected, the insertion selection menu to be promptly selected is displayed, a different configuration may be used. For example, the determination condition for steps S405 and S410 may be adjusted by the touch operation for a short time or a press operation for a long time. In the touch operation for a short time, for example, all the selected preview images are inserted. On the other hand, in the press operation for a long time, the insertion selection menu is displayed and the above operation is performed. Such an operation allows reducing the number of operation steps to improve the operability of the user.

The first exemplary embodiment is described above on the assumption that, if the preview images to be moved are selected, the display of the selected preview images is deleted. In the fourth exemplary embodiment, there is described the example where, if the insertion operation is performed when the plurality of the preview images to be moved is selected, the selected preview images are displayed.

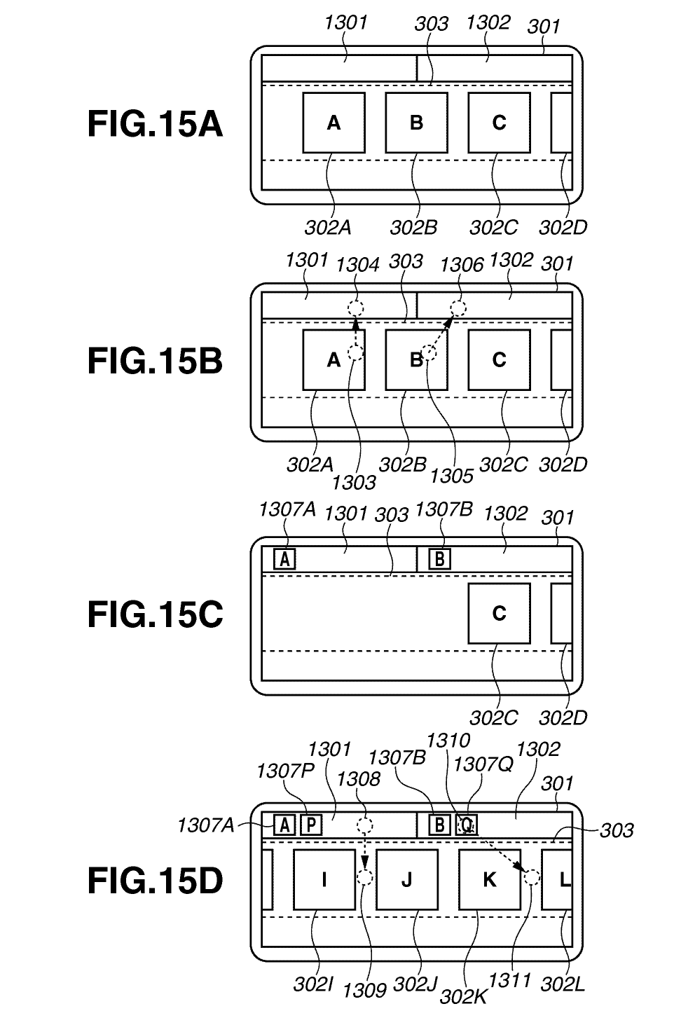

However, it is also assumed that, if the preview images to be moved are selected, the preview images are displayed outside the object display area 303. In a fifth exemplary embodiment, an operational example of the operation terminal 100 is described below according to the exemplary embodiment. More specifically, there is described below the example where the preview images to be moved are displayed outside the object display area 303 and the user intuitively adjusts the position of a page with the finger. FIGS. 15A to 15D illustrate an operational concept in this case.

FIG. 15A illustrates an example of a layout of the display screen 301 on the touch screen display 201 of the operation terminal 100 according to the present exemplary embodiment. The display screen 301 displays not only the object display area 303 but also buffer areas 1301 and 1302 for displaying the preview images recognized as those to be moved.

In this example, the preview images 302A and 302B are to be moved. In this case, the drag operation is performed on the touch screen display 201 from a display position 1303 of the preview image 302A to the buffer area 1301 and the finger is released at a position 1304 as illustrated in FIG. 15B. In addition, the drag operation is performed from a display position 1305 of the preview image 302B to the buffer area 1302 and the finger is released at a position 1306. FIG. 15C illustrates a state of the display screen 301 appearing after the finger is released on. The preview images 302A and 302B are displayed as thumbnail images 1307A and 1307B respectively.

Such a configuration allows the user to intuitively grasp which preview image is currently selected as an image to be moved. The use of a plurality of buffer areas allows classifying preview images as those of their respective other selection groups.

FIG. 15D illustrates a display example in a case where the user further selects two preview images to be moved in the buffer areas 1301 and 1302. In other words, two thumbnail images 1307P and 1307Q are displayed in the buffer areas 1301 and 1302, respectively.

Let us assume that the movement operation is performed from a display position 1308 in the buffer area 1301 to an insertion position 1309 between the preview images 302I and 302J with the finger touched. All the preview images corresponding to the thumbnail images displayed in the buffer area 1301 are inserted into the insertion position 1309.

On the other hand, if the movement operation is performed from a display position 1310 of the thumbnail image 1307Q in the buffer area 1302 to an insertion position 1311 between the preview images 302K and 302L with the finger touched, only the preview image corresponding to the thumbnail image 1307Q is inserted into the insertion position 1311

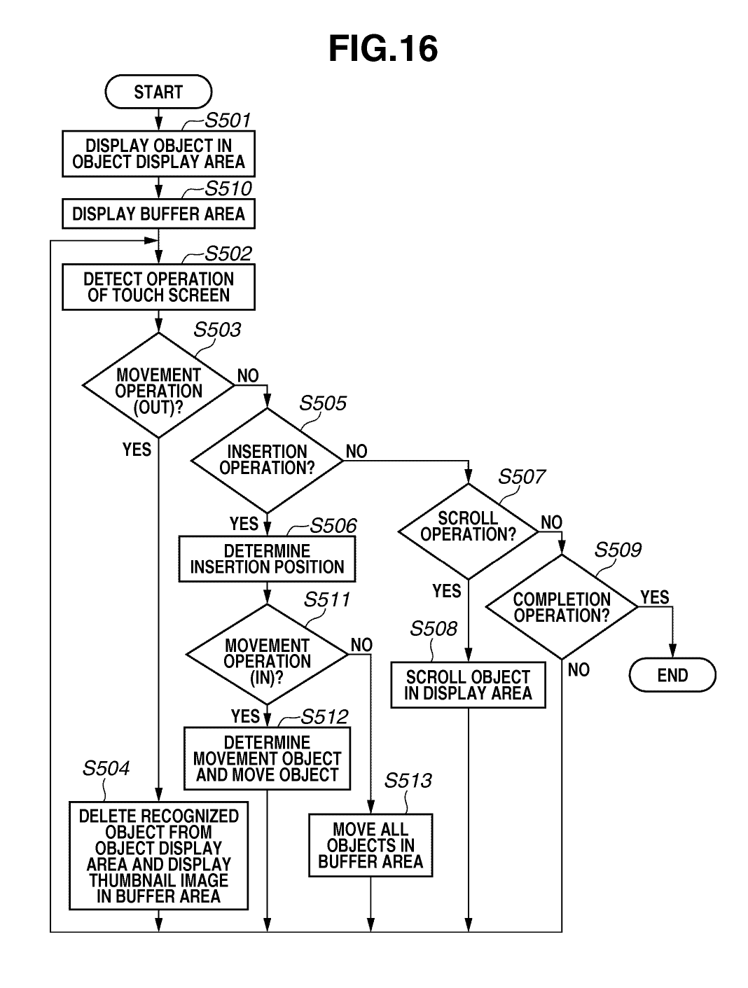

The operational contents of the operation terminal 100 enabling such processing are described below with reference to FIG. 16. FIG. 16 illustrates control procedures executed by the operation control unit (CPU) 105. Steps S501 to S502 are similar to steps S101 to S102 in FIG. 8 respectively. Steps S507 to S509 are similar to steps S107 to S109 in FIG. 8 respectively. Therefore, the description of the duplicated portions is omitted.

In step S501, the operation control unit 105 displays the preview images in the object display area 303. In step S510, the operation control unit 105 displays buffer areas 1301 and 1302. At this point, only if the size of the touch screen display 201 is determined to be equal to or greater than a predetermined size, the buffer areas 1301 and 1302 may be displayed. Thus, only in the case of the operation terminal 100 wide in the display area, the buffer areas 1301 and 1302 can be displayed.

In the example of FIG. 15A, the two buffer areas 1301 and 1302 are displayed. However, fundamentally only one buffer area may be displayed, and a buffer area may be increased to two or more buffer areas as long as it is determined that the user's operation is the one for increasing the buffer area. Such a configuration can provide an operation environment depending on the needs of a user who wants to merely display the preview image or of a user who wants to use a plurality of buffer areas for classification.

In step S503, after the buffer area, one buffer area 1301, for example, is displayed, the operation control unit 105 determines whether the operation detected in step S502 is the movement operation (OUT) for moving the preview image from the object display area 303 to the buffer area 1301 (OUT). If the operation is the movement operation (OUT) (YES in step S503), in step S504, the display of the selected preview image is deleted from the object display area 303, and the operation control unit 105 performs control to display a thumbnail image in the buffer area 1301. The thumbnail image is the one that the corresponding preview image is reduced in size. The thumbnail image is stored in the RAM 107 along with the preview image. Alternatively, the corresponding preview image may not be stored in the RAM 107 and may be received from the MFP unit 120 as the preview image data as required.

If the operation detected in step S502 is not the operation for moving the preview image to the buffer area 1301 (OUT) (NO in step S503), the operation control unit 105 performs the following operation.

If the detected operation is the insertion operation from the buffer area 1301 to an insertion position between the preview images (YES in step S505), in step S506, the operation control unit 105 determines the insertion position. In other words, the operation control unit 105 determines the position between the touched position between the preview images as the insertion position. After that, in step S511, the operation control unit 105 determines whether the operation detected in step S502 is the movement operation (IN) for moving the thumbnail image in the buffer area 1301 to the insertion position (IN). If the operation is the movement operation (IN) (YES in step S511), in step S512, the operation control unit 105 determines the corresponding preview image and inserts it into the insertion position. If the operation is not the movement operation (IN) (NO in step S511), in step S513, the operation control unit 105 inserts all the preview images corresponding to the thumbnail images displayed in the buffer area 1301 into the insertion position.

When the selection of the preview image to be moved is recognized, such a configuration enables displaying the thumbnail image of the recognized preview image outside the object display area 303. For this reason, the present exemplary embodiment can provide the user with an operation environment which can more intuitively perform the movement of pages of the preview image than the operation environment in the first to fourth exemplary embodiments.

In the first to fifth exemplary embodiments, the preview image or the thumbnail image is cited as an example of an object to be displayed. However, an icon image may be used as the object. In a sixth exemplary embodiment, there is described an example where the position of an icon image is adjusted on the screen of the operation terminal 100. The hardware configuration of the operation terminal 100 and the movement procedure of an object are similar to those in the first to fifth exemplary embodiments. Therefore, the description of the duplicated portions is omitted.

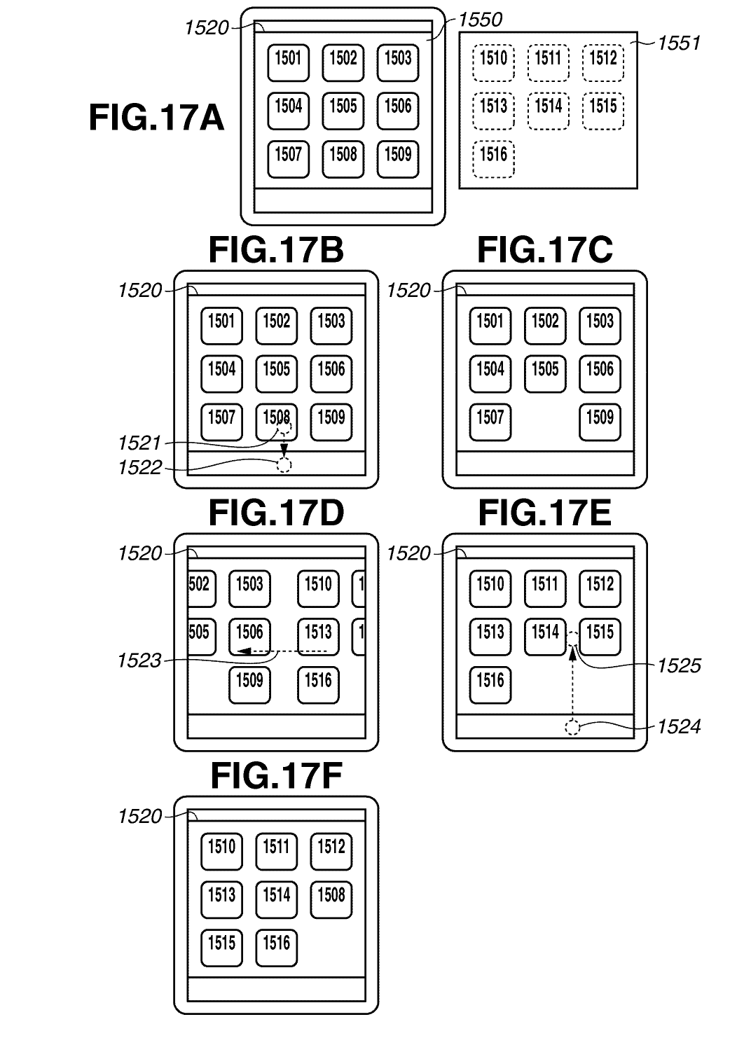

FIGS. 17A to 17F illustrate the concept of a user interface in the present exemplary embodiment. FIG. 17A illustrates an example of a display screen 1550 with a plurality of icon images, which is displayed on the liquid crystal display 102 of the operation terminal 100. In the illustrated example, nine icon images 1501 to 1509 are displayed in an object display area 1520. Although not illustrated in the liquid crystal display 102, a latent image 1551 on the next page exists on the right side of the display screen 1550. Seven icon images 1510 to 1516 are displayably arranged on a latent screen 1551.

In such a display condition, let us assume that one icon image 1508 is desired to be moved to another position. In this case, as illustrated in FIG. 17B, a display position 1521 of the icon image 1508 on the touch screen 101 of the operation terminal 100 is touched. Thereafter, the display position 1521 is dragged to a position 1522 outside the object display area 1520. When the drag operation is completed, as illustrated in FIG. 17C, the display of the icon image 1508 is deleted from the object display area 1520.

It is assumed that the icon image 1508 is desired to be moved to a space between the icon images 1514 and 1515 arranged on the latent screen 1551. In this case, as illustrated in FIG. 17D, the finger touching the touch screen 101 is scrolled from the right to the left direction 1523. The scroll operation starts gradually displaying the icon images 1510 to 1516 in the latent screen 1551 on the liquid crystal display 102.

When a position into which an icon image is desired to be inserted is displayed, as illustrated in FIG. 17E, a position 1524 outside the object display area 1520 is touched. The finger is moved from the position 1524 to a position 1525 into which the icon image is desired to be inserted with the finger touching the touch screen 101. This operation determines the insertion position 1525 and the icon image 1508 is inserted into the insertion position 1525. Thereby, the movement of the icon image is completed. FIG. 17F illustrates the display screen 1550 acquired after the movement of the icon image is completed.

Thus, in the sixth exemplary embodiment, the selection of an icon image desired to be moved on the touch screen display 201 completes one process. Then, all of the other icon images excluding the selected icon image are moved. When an insertion position at a movement destination is displayed, the insertion position is specified and the previously selected icon image is inserted thereinto. For this reason, the user can be provided with an operation environment in which the position of intuitive and easily understandable icon image is adjusted.

In the exemplary embodiments, a configuration is described in which the operation terminal 100 communicates with the MFP unit 120 via the network. However, a configuration may be used in which the operation terminal 100 is integrated with the MFP unit 120. In other words, the abovementioned functions may be performed using the touch screen display as the user interface for operating the image processing apparatus.

The present disclosure can be applied to any apparatus equipped with a touch screen display such as a cellular phone, a tablet, a personal digital assistant (PDA), and a digital camera, as well as the operation terminal 100 operating the MFP unit 120.

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a CPU, micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, if at least one object selected by the selection operation in the object display area is retracted, the display thereof is deleted. This eliminates the need for maintaining a touch on the object for the purpose of the next operation to facilitate operation. Thereby, the problems of a conventional technique are resolved.

When the remaining objects are scrolled and reached to an insertion position, the insertion operation associated with the specification of an insertion apparatus is merely performed to insert the retracted object into the insertion position. This allows realizing an extraction of the object, the movement of display of the remaining objects, and the insertion of the retracted object as the respective independent operations.

Thereby, the user can be provided with intuitive, easily understandable, and efficient operability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2012-261940 filed Nov. 30, 2012, which is hereby incorporated by reference herein in its entirety.

What is claimed is:

1. An operation apparatus comprising:
an object display unit configured to display a plurality of objects in an object display area of a display screen which can be operated by a finger or a pen;
a selection unit configured to retract at least one target object in the object display area, the at least one target object being selected by a selection operation, outside the object display area, and to delete the display of the at least one target object;
a scrolling unit configured to scroll the objects remaining in the object display area in a direction in which a scroll operation is performed in the object display area; and
an insertion unit configured to insert the at least one target object into an insertion position specified by an insertion operation in the object display area, and to update the display of the objects in the object display area.

2. The operation apparatus according to claim 1, further comprising a confirmation unit configured to display a confirmation screen for urging a determination as to whether to perform a completion without inserting the at least one target object which is being retracted when a completion operation is instructed before the at least one target object which is being retracted is inserted.

3. The operation apparatus according to claim 1, wherein the insertion unit records positional information about the insertion position specified by the insertion operation in a predetermined memory before the selection operation of the at least one target object is performed and inserts, after the at least one target object is selected by the selection unit, the selected at least one target object into the insertion position determined by the positional information.

4. The operation apparatus according to claim 3, further comprising an order confirmation unit configured to display an insertion selection screen for urging a determination of an insertion order on the display screen when the selected at least one target object is plural in number, and to detect the insertion order of a plurality of selected target objects,
wherein the insertion unit inserts the plurality of target objects into the insertion position according to the insertion order.

5. The operation apparatus according to claim 4, wherein the order confirmation unit selectively executes the insertion of all the plurality of selected target objects and the display of the insertion selection screen according to the duration time of a touch operation on the display screen.

6. The operation apparatus according to claim 1, further comprising a buffer area display unit configured to display a buffer area outside the object display area of the display screen,
wherein the selection unit converts the at least one target object to be retracted into a reduced object in which a display size of the at least one target object is reduced, and displays the reduced object in the buffer area, and
the insertion unit inserts the at least one target object corresponding to the reduced object into the insertion position when a movement operation of a specific reduced object in the buffer area to the object display area is detected on the display screen.

7. The operation apparatus according to claim 6, wherein, if a plurality of the reduced objects exists in the buffer area, the insertion unit inserts target objects corresponding to all the reduced objects existing in the buffer area into the insertion position when the movement operation from the buffer area to the object display area is detected without any of reduced objects being specified.

8. The operation apparatus according to claim 6, wherein the buffer area display unit displays the buffer area if the size of the display screen exceeds a predetermined size.

9. The operation apparatus according to claim 6, wherein the buffer area display unit forms the buffer areas the number of which complies with an instruction and displays the buffer areas in the display screen.

10. The operation apparatus according to claim 1, wherein the plurality of objects is a plurality of page or icon images grouped in a form in which their respective page or icon images can be independently operated,
the object display area is displayed for each group,
the selection unit retracts one target object by one from the plurality of objects outside the group according to a predefined selection operation pattern, and
the insertion unit inserts the target object retracted outside the group into a previous or a subsequent area of other objects remaining in the object display area according to a predefined insertion operation pattern.

11. The operation apparatus according to claim 10, wherein the selection operation pattern is any pattern of a drag operation of the target object outside the group and a pinch-in operation of two successive objects, and
the insertion operation pattern is any pattern of a touch operation on a space between two successive objects, a synchronous touch operation on two successive objects, a pinch-out operation from the space between two successive objects to the two objects, and a touch operation on a predetermined image displayed in a space between two objects.

12. The operation apparatus according to claim 1, further comprising a transmission unit configured to transmit to a predetermined image processing apparatus the plurality of objects and operational contents applied to the objects.

13. The operation apparatus according to claim 12, wherein the transmission unit performs transmission via a wireless communication line.

14. An image forming apparatus including an operation apparatus operated by a user and an image processing apparatus operating in collaboration with the operation apparatus,
wherein the operation apparatus is the operation apparatus according to claim 1, and
the image processing apparatus includes a communication unit configured to communicate with the operation apparatus and an image processing unit configured to transmit a plurality of objects to the operation apparatus via the communication unit and to subject the plurality of objects to image processing reflecting the operational contents which the operation apparatus applies to the plurality of objects.

15. A method for controlling an operation apparatus comprising:
displaying a plurality of objects in an object display area of a display screen which can be operated by a finger or a pen;
retracting at least one target object in the object display area, the at least one target object being selected by a selection operation, outside the object display area as well as deleting the display of the at least one target object;
scrolling the objects remaining in the object display area in a direction in which a scroll operation is performed in the object display area; and
inserting the at least one target object into an insertion position specified by an insertion operation in the object display area as well as updating the display of the objects in the object display area.

16. A storage medium storing a computer program for operating a computer as an operation apparatus, the storage medium for causing the computer to function as:
an object display unit configured to display a plurality of objects in an object display area of a display screen which can be operated by a finger or a pen;
a selection unit configured to retract at least one target object in the object display area, the at least one target object being selected by a selection operation, outside the object display area and to delete the display of the at least one target object;
a scrolling unit configured to scroll the objects remaining in the object display area in a direction in which a scroll operation is performed in the object display area; and
an insertion unit configured to insert the at least one target object into an insertion position specified by an insertion operation in the object display area and to update the display of the objects in the object display area.
